(19) United States
(12) Patent Application Publication
(10) Pub. No.: US 2026/0346642 A1
(43) Pub. Date: Nov. 5, 2026

(54) WHEEL BEARING FOR WHEEL-MOUNTED ELECTRIC MOTOR

(71) Applicant: AUDI AG, Ingolstadt (DE)

(72) Inventors: Johannes ALBL, Ingolstadt (DE); Michael FRISCH, Schönberg (DE)

(73) Assignee: AUDI AG, Ingolstadt (DE)

(21) Appl. No.: 19/574,668

(22) Filed: Mar. 23, 2026

(30) Foreign Application Priority Data
Apr. 30, 2025 (DE) 102025116680.3

(51) Int. Cl. B60B 27/00; B60B 27/04; B60K 7/00; F16C 19/18

(52) U.S. Cl. CPC B60B 27/0026; B60B 27/0052; B60B 27/0094; B60B 27/04; B60K 7/0007; F16C 19/18

(57) ABSTRACT

A wheel bearing includes a roller bearing for rotatably mounting a wheel hub. An inner ring of the roller bearing is designed to be stationary; and an outer ring of the roller bearing is designed to rotate. The outer ring has a wheel flange and wherein the outer ring has teeth which are configured to be driven with the aid of a machine.

### FIELD

The present invention relates to a wheel bearing, in particular for a wheel-mounted, furthermore in particular electric, machine, as well as a wheel hub drive having a corresponding wheel bearing.

### BACKGROUND

Wheel-mounted electric motors are usually connected to a wheel bearing via a transmission. The electric motor and transmission typically require a large amount of installation space in the axle for this purpose, which is either not available or has to be acquired via significant limitations in components and vehicle kinematics. Typically, the wheel bearing is driven via a splined connection, wherein the outer ring, which is usually stationary, is screwed onto the wheel carrier. Conventional passenger vehicle wheel bearings are usually designed so that the roller bodies are arranged on the vehicle inside and the wheel flange is on the vehicle outside.

### SUMMARY

It is therefore an object of the present invention to improve and/or simplify a chassis, in particular a wheel bearing, preferably to reduce one or more of the above-mentioned disadvantages, preferably to avoid them.

According to any one embodiment of the present invention, a wheel bearing for a motor vehicle is provided. In one embodiment, the wheel bearing has a roller bearing for rotatably mounting a wheel hub. In one embodiment, the roller bearing has an inner ring, wherein the inner ring is designed to be stationary, in particular is arranged stationary or fixed in the wheel bearing, especially in or on a wheel carrier of the wheel bearing. In one embodiment, the inner ring has two or more parts, wherein in a refinement, one or more of the parts of the inner ring can be or are formed fixed in place. In one embodiment, the roller bearing (of the wheel bearing) has an outer ring, wherein the outer ring is designed to rotate. In one embodiment, the outer ring has teeth. In one embodiment, the teeth are configured to be driven with the aid of a machine, in particular an electric machine, in particular indirectly or directly.

Advantageously, this allows the wheel bearing to have a large or larger installation space, in particular compared to internally running rings, in one design. Furthermore, in one embodiment, this can create or free axial installation space, which can offer or offers space or more space for a machine, in particular an electrical machine. Furthermore, in one embodiment, this can advantageously reduce the number of parts, in particular weight, costs, and/or installation space are reduced, especially further.

In one embodiment, the wheel bearing is configured to be driven parallel to the axle or centrally to the wheel bearing, in particular centrally, and furthermore in particular centrally to the wheel. In one embodiment, a machine, in particularly an electric machine, is arranged parallel to the axis and/or has a torque transmission that can act parallel to the axis (to the wheel) on the teeth of the outer ring, or the wheel bearing, in one embodiment, is configured for this purpose. In an alternative embodiment, the wheel bearing is configured to absorb the torque of a machine arranged centrally to the wheel bearing, in particular an electric machine, or of a torque transmission of a machine, in particular an electric machine, (guided) centrally to the wheel bearing, with the aid of the teeth of the outer ring, in particular to be driven in such a way.

Advantageously, this allows, in one embodiment, for a torque transmission to the teeth of the outer ring to take place, in particular depending on the available installation space or the space requirements of the machine; and thus advantageously, in one embodiment, installation space or parts can be saved. In particular, in one embodiment, a seal of the wheel bearing can be implemented (more) easily in this way.

In one embodiment, the wheel bearing has an axle journal, wherein the axle journal is designed to receive the inner ring. In one embodiment, the axle journal is designed to mount the inner ring, in particular in a fixing manner. In one embodiment, the axle journal is arranged in the wheel carrier, or the wheel carrier, in one embodiment, is designed or configured to receive an axle journal. In one embodiment, the axle journal and the inner ring are formed in one piece. In one refinement, the inner ring, which is flanged in particular, is configured to be fastened on the wheel carrier, in particular to become or be screwed to the wheel carrier. In one embodiment, the inner ring, which is loose in particular, is configured to become or be clamped, with the aid of a roller rivet, in particular to the bearing.

Advantageously, this allows the number of parts to be (further) reduced in one embodiment. Furthermore, in one embodiment, this eliminates the need for a clamping means, in particular for clamping or securing the axle journal.

In one embodiment, the teeth of the outer ring are designed to provide a transmission ratio for a drive, in particular a or the, furthermore in particular electric, machine.

Advantageously, this makes it possible, in one embodiment, to eliminate a transmission in the wheel bearing, in particular a planetary gear. Advantageously, in one embodiment, the teeth can be tailored to a machine, in particular an electric machine, in particular to provide a predetermined transmission ratio. In one embodiment, a torque transmission to the teeth can be configured, in particular additionally, to set or provide a predetermined transmission ratio.

In one embodiment, the teeth of the outer ring have external teeth or, in one embodiment, are designed as such. In one embodiment, the teeth of the outer ring are arranged on a (radial) outer side or surface. In one, in particular alternative, embodiment, the teeth of the outer ring have internal teeth or, in one embodiment, are designed as such. In one embodiment, the internal teeth are configured to be driven with the aid of a (drive) shaft of a machine, in particular an electric machine, in particular with the aid of a wheel or spur wheel. In one embodiment, a torque transmission from the machine, in particularly an electric machine, to the teeth of the outer ring includes a transmission ratio with the aid of a planetary gear. In one refinement, the planetary gear is arranged on the machine, in particular an electric machine, and/or on the outside of the vehicle, in particular on or at the teeth of the outer ring.

Advantageously, in one embodiment, this enables a high or higher transmission ratio to be achieved. In one embodiment, this advantageously eliminates the need for a transmission, in particular an axially arranged transmission, furthermore in particular a planetary gear, in particular installation space can be “saved” in this way. In an embodiment with internal teeth, in one embodiment, a seal can advantageously be produced (more) easily or the wheel bearing can be sealed more easily, in particular the teeth can be (more) maintenance-free. Furthermore, in one embodiment, friction of the wheel bearing can be reduced by reducing the number of (required) seals.

In one embodiment, a roller body of the roller bearing is arranged axially on the vehicle outside, in particular in comparison to the vehicle inside. In one refinement, a wheel flange is arranged axially farther inwards in the vehicle than the roller body. In one embodiment, the roller body, in particular one or its, in particular outer, raceway, is arranged in the axial direction below the brake disc chamber or the wheel centering feature.

Advantageously, in one embodiment, this can make it possible to center a wheel (more) easily, in particular with the aid of the wheel bearing. Advantageously, in one embodiment, this can make it possible for the wheel bearing, in particular its roller bearing, to be exchanged and/or overhauled (more) easily.

In one embodiment, the wheel flange is configured to center a wheel. In one embodiment, the outer ring additionally or alternatively has a centering feature, in particular a cover, furthermore in particular a pressed-in cover, which is designed to center the wheel and/or to seal the wheel bearing.

Advantageously, in one embodiment, this can make it possible to center a wheel (more) easily with the aid of the wheel bearing.

according to any one embodiment of the present invention, a wheel hub drive is provided. In one embodiment, the wheel hub drive includes a wheel bearing as described herein. In one embodiment, the wheel hub drive includes a machine, in particular an electric machine. In one embodiment, the electric machine is configured to drive the wheel bearing with the aid of the teeth, in particular directly or via a transmission ratio with the aid of the teeth. In one embodiment, the electric machine is configured to be driven via the teeth, in particular to be operated as a generator (with the aid of the teeth).

Advantageously, in one embodiment, the electric machine can be enabled to introduce a drive and/or a recuperation torque into the wheel bearing.

In one embodiment, the machine, in particular an electric machine, is arranged on or at the wheel carrier of the wheel bearing or on the wheel carrier of a vehicle, or is connected to the wheel carrier, in particular with the aid of fastening means. In one embodiment, a drive shaft of the, in particular electric, machine is guided through the wheel carrier; in particular, the wheel carrier has, in one embodiment, a passage and/or a receptacle for the drive shaft, which is configured in particular to direct or transmit torque to the teeth of the wheel bearing.

Advantageously, in one embodiment, this can enable the wheel hub drive to be designed in a (more) compact form, and in particular to have few(er) parts. Advantageously, in one embodiment, this enables a large or larger machine, in particular an electric machine, to be used.

Any terms used herein, such as “comprises”, “contains”, “includes”, “indicates”, “has”, “with”, or any other variant thereof, are intended to cover non-exclusive inclusion. For example, a method or device that comprises or includes a list of elements is not necessarily limited to those elements, but may include other elements that are not expressly listed or that are inherent in such a method or device.

The terms “a” or “one”, as used here, are defined in the sense of “one or more”. The terms “another” and “a further” as well as any other variant thereof are to be understood in the sense of “at least one more”.

The terms “configured” or “set up” to fulfill a specific function (and any variations thereof), as possibly used here, are to be understood as meaning that a device or component thereof is already in a design or setting in which it can perform the function, or at least is adjustable—i.e. configurable—so that it can perform the function after appropriate adjustment. The configuration can be carried out, for example, via corresponding adjustment of parameters of a process sequence or by switches or the like to activate or deactivate functionalities or settings. In particular, the device can have several predetermined configurations or operating modes, so that the configuration can be carried out by selecting one of these configurations or operating modes.

### BRIEF DESCRIPTION OF THE FIGURES

Further advantages, features, and possible uses of the present invention will be apparent from the following detailed description in conjunction with the figures. In the figures:

FIG. 1 schematically shows an embodiment of a wheel bearing;

FIG. 2 schematically shows another embodiment of a wheel bearing; and

FIG. 3 schematically shows another embodiment of the wheel bearing.

### DETAILED DESCRIPTION

In the figures, identical reference numerals denote identical, similar, or corresponding elements. Elements depicted in the figures are not necessarily shown to scale. Rather, the various elements depicted in the figures are rendered in such a way that their function and general purpose become understandable to those skilled in the art. Connections and couplings between functional units and elements shown in the figures can also be implemented as indirect connections or couplings, unless explicitly stated otherwise. Functional units can be implemented in particular as hardware, software, or a combination of hardware and software.

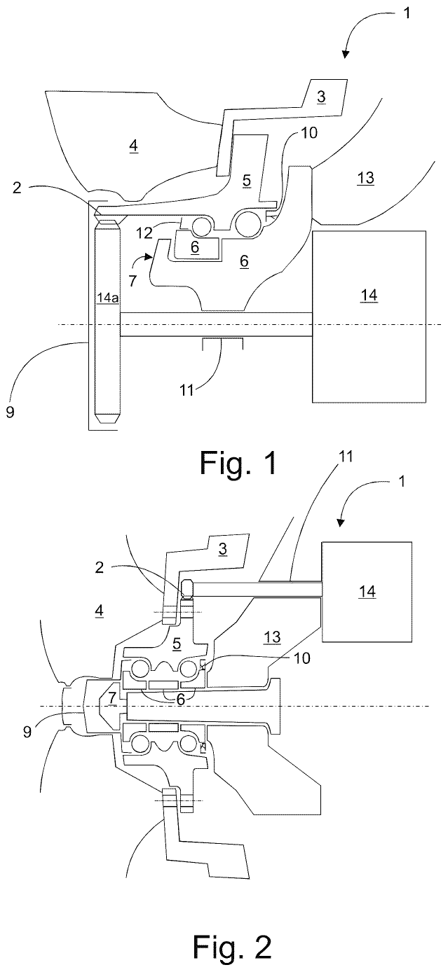

FIG. 1 schematically shows an embodiment of a wheel bearing 1. The wheel bearing 1 shown has stationary inner rings 6 of a roller bearing, in which the outer ring 5 is designed to rotate and has teeth 2. The teeth 2 provide a transmission ratio so that a transmission, in particular an axially arranged transmission, in particular a planetary gear, can be eliminated. The embodiment shown in FIG. 1, in particular having a spur gear 14a, has, without restricting the generality, a transmission ratio of, at least essentially, 1:1. One of the inner rings 6 is connected to the wheel carrier 13, in particular with the aid of fastening means (not shown here). Furthermore, a brake disc 3 is indicated in FIG. 1, as well as a grease retention disc 12 on the roller bearing, without restricting the generality. Additionally, sealing rings are shown, also without restricting the generality, as well as a clamping device 7, which can be designed as a roller rivet (as shown) in one embodiment, with the aid of which, in one embodiment, the wheel bearing can be pre-tensioned and/or the wheel bearing becomes self-supporting. Furthermore, a machine 14, in particular an electric machine, is shown which acts or can act on the teeth 2, in particular via a drive shaft. In one embodiment, the torque transmission from the machine 14 to the teeth 2 includes a transmission, in particular a planetary gear. In one embodiment, the transmission is arranged close to or on the machine 14; in particular, the machine 14, in one embodiment, has a transmission or a transmission ratio; or is arranged on the teeth 2, in one refinement instead of the spur gear 14a. The wheel bearing 1 can, in one embodiment, have a passage 11 for the drive shaft for this purpose. In the embodiment shown, it is centrally arranged, in particular concentrically with the wheel axle. Furthermore, a sealing cap 9 is shown on the wheel side.

FIG. 2 shows another embodiment of a wheel bearing 1. In this embodiment shown, the wheel bearing 1 has an axle journal which-as schematically shown-is mounted in the wheel carrier 13, wherein the roller bearing is arranged or clamped or pre-tensioned on the axle journal with the aid of a clamping means 7. Furthermore, a wheel-side sealing cap 9 is shown. In one embodiment, this can be pressed into the outer ring 5 and, in another embodiment, it can be used as a centering feature for the wheel 4 or can be designed for this purpose. The machine 14 is arranged axially parallel in FIG. 2 and drives the outer ring 5 via its teeth via a drive shaft, which in embodiments can be guided through a passage 11 and in FIG. 2 is guided by way of example through such a passage 11 in the wheel carrier 13. Furthermore, a brake disc 3 is indicated.

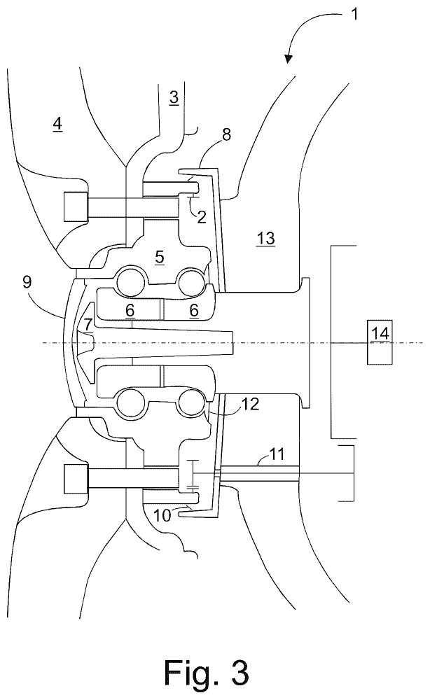

FIG. 3 schematically shows another embodiment of a wheel bearing. The wheel bearing 1 shown differs from the embodiments of the wheel bearings 1 of FIGS. 1 and 2 in that the machine 14, in particular an electric machine, is arranged on the wheel axle and is mechanically connected to the teeth 2 of the outer ring 5 via an axially-parallel (drive) shaft. The wheel carrier 13 can, in one embodiment, have a passage 11 for this purpose. Furthermore, the outer ring 5 is designed to provide a centering feature for the wheel 4. The embodiment of FIG. 3 furthermore includes an internal sealing cap 8, which in embodiments is sealed using a sealant, in particular a sealing ring 10. Furthermore, the embodiment of FIG. 3 is sealed via a further sealing cap 9 on the wheel side, so that, in particular due to this, easier sealing of the wheel bearing 1 can be or is implemented in embodiments. The teeth 2 are formed as internal teeth on the outer ring 5 in FIG. 3 and (advantageously, in particular in comparison to the embodiment of FIG. 2) are sealed by the sealing cap 8.

While at least one exemplary embodiment has been described above, it should be noted that a large number of variations exist. It should also be noted that the exemplary embodiments described are only non-limiting examples, and it is not intended to restrict the scope, applicability, or configuration of the devices and methods described herein. Rather, the preceding description will provide those skilled in the art with guidance on the implementation of at least one exemplary embodiment, wherein it is understood that various changes in the functioning and arrangement of the elements described in an exemplary embodiment may be made without deviating from the subject matter defined in the attached claims and its legal equivalents.

### List of reference numerals

1 wheel bearing
2 teeth
3 brake disc
4 wheel
5 outer ring
6 inner ring
7 clamping means
8 sealing cap
9 sealing cap (wheel side)
10 sealing ring
11 passage for drive shaft
12 grease retention disc
13 wheel carrier
14 machine

1. A wheel bearing, comprising:
a roller bearing for rotatably mounting a wheel hub, wherein an inner ring of the roller bearing is designed to be stationary;
and an outer ring of the roller bearing is designed to rotate, wherein the outer ring has a wheel flange and wherein the outer ring has teeth which are configured to be driven with the aid of a machine.

2. The wheel bearing according to claim 1, wherein the wheel bearing is configured to be driven parallel to the axle or centrally at the wheel bearing.

3. The wheel bearing according to claim 1, wherein the wheel bearing has an axle journal designed to receive the inner ring.

4. The wheel bearing according to claim 1, wherein the teeth of the outer ring are designed to provide a transmission ratio for the machine.

5. The wheel bearing according to claim 1, wherein the teeth of the outer ring have external teeth and/or internal teeth.

6. The wheel bearing according to claim 5, wherein a roller body of the roller bearing is arranged on the axial outside of the vehicle, in particular with respect to a wheel flange.

7. The wheel bearing according to claim 1, wherein the roller body, in particular an outer raceway, is arranged in the axial direction below the brake disc chamber or the wheel centering feature.

8. The wheel bearing according to claim 1, wherein the wheel flange is configured to center a wheel or wherein the outer ring has a cover configured to center the wheel.

9. The wheel hub drive comprising a wheel bearing according to claim 1, wherein the wheel hub drive comprises a machine, in particular an electric machine, which is configured to drive the outer ring via the teeth of the outer ring or to be operated by the outer ring.

10. The wheel hub drive according to claim 9, wherein the machine is arranged on a wheel carrier of a vehicle.

11. The wheel bearing according to claim 2, wherein the wheel bearing has an axle journal designed to receive the inner ring.

12. The wheel bearing according to claim 2, wherein the teeth of the outer ring are designed to provide a transmission ratio for the machine.

13. The wheel bearing according to claim 3, wherein the teeth of the outer ring are designed to provide a transmission ratio for the machine.

14. The wheel bearing according to claim 2, wherein the teeth of the outer ring have external teeth and/or internal teeth.

15. The wheel bearing according to claim 3, wherein the teeth of the outer ring have external teeth and/or internal teeth.

16. The wheel bearing according to claim 4, wherein the teeth of the outer ring have external teeth and/or internal teeth.

17. The wheel bearing according to claim 2, wherein the roller body, in particular an outer raceway, is arranged in the axial direction below the brake disc chamber or the wheel centering feature.

18. The wheel bearing according to claim 3, wherein the roller body, in particular an outer raceway, is arranged in the axial direction below the brake disc chamber or the wheel centering feature.

19. The wheel bearing according to claim 4, wherein the roller body, in particular an outer raceway, is arranged in the axial direction below the brake disc chamber or the wheel centering feature.

20. The wheel bearing according to claim 5, wherein the roller body, in particular an outer raceway, is arranged in the axial direction below the brake disc chamber or the wheel centering feature.
